(19) United States
(12) Patent Application Publication
(10) Pub. No.: US 2026/0277597 A1
(43) Pub. Date: Sep. 17, 2026

(54) METHOD AND DEVICE FOR CORRECTING MULTI-RESOURCE LEAK TO ENSURE CONTROL FLOW OF SOFTWARE

(71) Applicant: RESEARCH & BUSINESS FOUNDATION SUNGKYUNKWAN UNIVERSITY, Suwon-si (KR)

(72) Inventors: Eunseok LEE, Seongnam-si (KR); Jin Young KIM, Seoul (KR)

(21) Appl. No.: 19/569,016

(22) Filed: Mar. 17, 2026

(30) Foreign Application Priority Data
Mar. 17, 2025 (KR) 10-2025-0033930

(51) Int. Cl. G06F 8/70; G06F 8/41

(52) U.S. Cl. CPC G06F 8/70; G06F 8/433

(57) ABSTRACT

Disclosed is a method for correcting a multi-resource leak. The method for correcting a multi-resource leak includes: an information extraction step of extracting a source code and a resource leak from a dataset and extracting a method including the resource leak; a control flow identification step of identifying a control flow of an original code by classifying resource blocks related to resources in the method; a hierarchical structure identification step of identifying a hierarchical structure of the resources included in the resource blocks; and a resource leak correction step of correcting the resource leak through an artificial intelligence algorithm by using the source code and the hierarchical structure of the resources as input data.

### BACKGROUND OF THE INVENTION

### 1. Field of the Invention

The present invention relates to a method and a device for correcting a multi-resource leak, and more specifically, to a method and a device capable of correcting a multi-resource leak capable of automatically correcting a resource leak, which is a representative energy bug causing inefficient energy consumption of software, and ensuring a control flow of software.

### 2. Description of the Related Art

A resource leak is a problem that occurs because resources used in a program are not properly released, resulting in deterioration in memory and performance of a system. Such a problem is caused by an incorrect control flow in processing a process of dynamically allocating and releasing resources. Existing technologies may not ensure the original control flow, so that there is a limit to generating a correct patch.

Meanwhile, existing resource management techniques may be classified into a manual memory management method and an automatic memory management method.

The manual memory management method requires a developer to directly process the resource allocation and the deallocation, and has a high risk of resource leakage due to an error. In particular, in a complex application, a resource release may be omitted from a specific path due to a change in program flow, resulting in a problem of deteriorating overall reliability and stability of the system.

The automatic memory management method, that is, garbage collection, automatically releases unnecessary memory to reduce the burden on the developer, but the resource release may not be completely performed in a specific situation. In particular, when there are still references to an object, the garbage collector does not release the references, which may lead to a resource leak. In addition, it is pointed out as a problem that the timing of garbage collection may not be predicted, which may cause performance degradation.

In order to solve this problem, recently, compiler-based analysis tools have appeared, and a technology for tracking a control flow of a program and identifying and warning a path in which the resource release is omitted in advance has been developed. These technologies may contribute to improving the reliability and performance of the program, and are likely to become a new standard for resource management in the future.

However, even these latest studies do not guarantee the original control flow of resources after patching, so there is a limitation in that the control flow is changed and thus the correct patch may not be ensured, and since the patch is performed on a single resource, the correct patch may not be generated by omitting the resource in consideration of multi-resources. Thus, there is a problem that energy consumption steadily increases due to an unpatched resource leak.

### SUMMARY OF THE INVENTION

The present invention provides a method and a device for correcting a multi-resource leak capable of ensuring and patching an original control flow of single- and multi-resources.

In addition, the present invention provides a method and a device for correcting a multi-resource leak capable of improving a patch generation rate and patch accuracy.

A method for correcting a multi-resource leak according to an embodiment of the present invention may include: an information extraction step of extracting a source code and a resource leak from a dataset and extracting a method including the resource leak; a control flow identification step of identifying a control flow of an original code by classifying resource blocks related to resources in the method; a hierarchical structure identification step of identifying a hierarchical structure of the resources included in the resource blocks; and a resource leak correction step of correcting the resource leak through an artificial intelligence algorithm by using the source code and the hierarchical structure of the resources as input data.

In addition, the information extraction step may include: extracting a start line from the resource leak, and; extracting a start line and an end line of the method through the start line of the resource leak.

In addition, the control flow identification step may include outputting a block related to the resource as a resource block, and outputting a block not related to the resource as a non-resource block, by using the source code, the start line and the end line of the method, and the hierarchical structure (AST) of the source code as input data.

In addition, the control flow identification step may include identifying the hierarchical structure of the resources by determining dependency between the resources included in the resource blocks.

In addition, the artificial intelligence algorithm may be a large language model (LLM).

In addition, the method for correcting a multi-resource leak may include storing a program in a computer-readable recording medium.

A device for correcting a multi-resource leak according to an embodiment of the present invention may include: an information extraction unit configured to extract a source code and a resource leak from a dataset and extracting a method including the resource leak; a control flow identification unit configured to identify a control flow of an original code by classifying resource blocks related to resources in the method; a hierarchical structure identification unit configured to identify a hierarchical structure of the resources included in the resource blocks; and a resource leak correction unit configured to correct the resource leak through an artificial intelligence algorithm by using the source code and the hierarchical structure of the resources as input data.

In addition, the information extraction unit may extract a start line from the resource leak, and extract a start line and an end line of the method through the start line of the resource leak.

In addition, the control flow identification unit may output a block related to the resource as a resource block, and output a block not related to the resource as a non-resource block, by using the source code, the start line and the end line of the method, and the hierarchical structure (AST) of the source code as input data.

In addition, the control flow identification unit may identify the hierarchical structure of the resources by determining dependency between the resources included in the resource blocks.

According to the present invention, the control flow of the original code is identified by classifying the resource blocks related to the resources in the method including the resource leak, and the resource leak is corrected by identifying the hierarchical structure of the resources included in the resource block, so that it is possible to ensure and patch the original control flow of single- and multi-resources.

In addition, according to the present invention, the high patch generation rate and accuracy may be provided compared to SOTA studies showing the latest high performance results.

### BRIEF DESCRIPTION OF THE DRAWINGS

FIG. 1 is a view showing a configuration of a device for correcting a multi-resource leak to ensure a control flow of software according to an embodiment of the present invention.

FIG. 2 is a view showing a processing process of the device for correcting a multi-resource leak of FIG. 1.

FIG. 3 is a view showing a context analysis process of a source code of Table 1.

FIG. 4 is a view showing three criteria for identifying dependency between resources according to the embodiment of the present invention.

FIG. 5 is a flowchart showing a method for correcting a multi-resource leak according to an embodiment of the present invention.

### DETAILED DESCRIPTION OF THE INVENTION

Hereinafter, preferred embodiments of the present invention will be described in detail with reference to the accompanying drawings. However, the present invention may be embodied in different forms and should not be construed as limited to the embodiments set forth herein. Rather, the embodiments introduced herein are provided so that the disclosed contents may be thorough and complete and the spirit of the present invention may be sufficiently conveyed to those skilled in the art.

In the present specification, it will be understood that when an element is referred to as being “on” another element, it may be formed directly on the other element or intervening elements may be present. In the drawings, the thicknesses of layers and regions are exaggerated for clarity.

In addition, it will be also understood that although the terms first, second, third, etc. may be used herein to describe various elements, these elements should not be limited by these terms. These terms are only used to distinguish one element from another element. Thus, a first element in some embodiments may be termed a second element in other embodiments without departing from the teachings of the present invention. Embodiments explained and illustrated herein include their complementary counterparts. As used herein, the term “and/or” includes any and all combinations of one or more of the associated listed elements.

The singular expression also includes the plural meaning as long as it does not differently mean in the context. In addition, the terms “comprise”, “have” etc., of the description are used to indicate that there are features, numbers, steps, elements, or combinations thereof, and they should not exclude the possibilities of combination or addition of one or more features, numbers, operations, elements, or a combination thereof. Furthermore, it will be understood that when an element is referred to as being “connected” or “coupled” to another element, it may be directly connected or coupled to the other element or intervening elements may be present.

In addition, when detailed descriptions of related known functions or constitutions are considered to unnecessarily cloud the gist of the present invention in describing the present invention below, the detailed descriptions will not be included.

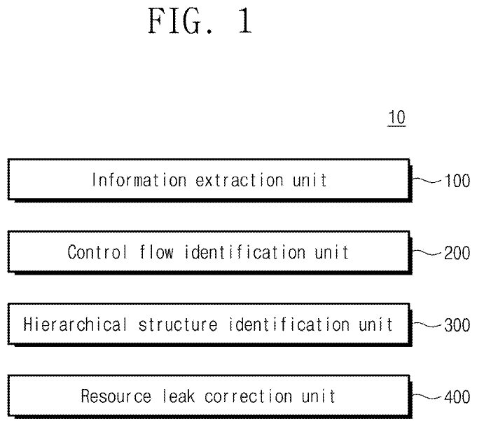

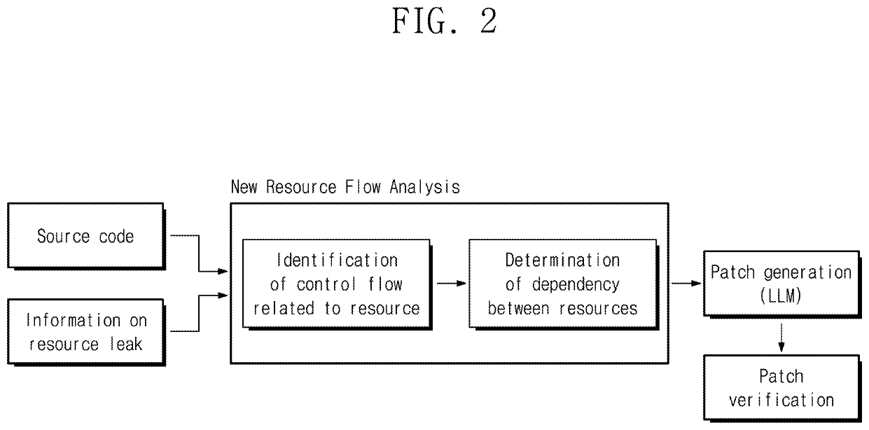

FIG. 1 is a view showing a configuration of a device for correcting a multi-resource leak to ensure a control flow of software according to an embodiment of the present invention, and FIG. 2 is a view showing a processing process of the device for correcting a multi-resource leak of FIG. 1.

Referring to FIGS. 1 and 2, a device 10 for correcting a multi-resource leak to ensure a control flow of software may automatically correct a resource leak, which is a representative energy bug that causes inefficient energy consumption of software.

The device for correcting a multi-resource leak to ensure a control flow of software may be a program executable in a computing device, and may be stored in a recording medium readable by the computing device. The computing device may be configured in the form of a notebook, a desktop, a laptop, a portable terminal, a tablet PC, and the like, but is not limited thereto, and may be configured in the form of another device having a computing function.

The device 10 for correcting a multi-resource leak to ensure a control flow of software includes an information extraction unit 100, a control flow identification unit 200, a hierarchical structure identification unit 300, and a resource leak correction unit 400.

The information extraction unit 100 extracts information on a source code and a resource leak from a dataset, and extracts a method including the resource leak. The dataset refers to a set of data collected for a specific purpose in the execution of software.

The dataset includes the source code and the resource leak. The source code is a program or script that performs processing, conversion, and analysis on the dataset, and performs tasks such as reading, filtering, and refining the dataset. The resource leak is a problem that occurs because the program does not release resources that are no longer needed, and mainly includes memory, file handles, and network connections. The method is a type of function defined in a class in object-oriented programming, and provides a function of manipulating data of a specific object (instance), changing a state of an object, or performing a specific operation.

The information extraction unit 100 extracts information on the source code and the resource leak from the dataset, and extracts the method including the resource leak. According to the embodiment, the information extraction unit 100 extracts a start line (start_line) of the resource leak as information on the resource leak, and extracts a start line and an end line of the method as method information.

The control flow identification unit 200 identifies a control flow of an original code by classifying a resource block related to the resource and a non-resource block not related to the resource in the method. To this end, the control flow identification unit 200 performs a context analysis of the source code and the method. The control flow identification unit 200 outputs the resource block and the non-resource block by using the source code, the start line and the end line of the method, and an abstract syntax tree (AST) as input data.

The abstract syntax tree (AST) is a data structure used in a computer programming language, and hierarchically represents a structure of the source code. The AST is generated as a result of the syntactic analysis, and represents a semantic structure of the source code.

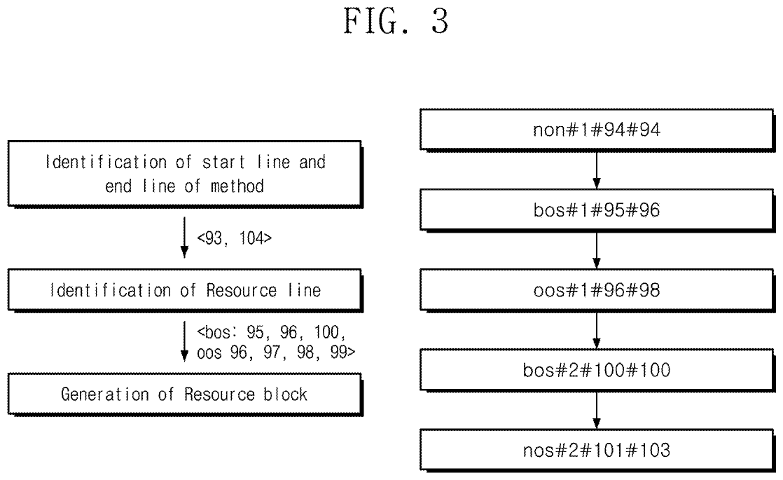

According to one example, the control flow identification unit 200 may analyze a context as shown in [Table 2] when the source code shown in [Table 1] is input. FIG. 3 is a view showing a context analysis process of a source code of Table 1.

TABLE 1

93 private byte[ ] serialize(Serializable value) {
94 try {
95 ByteArrayOutputStream bos = new ByteArrayOutputStream( );
96 ObjectOutputStream oos = new ObjectOutputStream(bos);
97 oos.writeObject(value);
98 oos.flush( );
99 oos.close( );
100 return bos.toByteArray( );
101 } catch(Exception e) {
102 throw new CacheException(“Error” + e);
103 }
104 }

TABLE 2

| Context | Block#N: | Resource Name#Order#Start Line#End Line |
|---|---|---|
| Context | Block#1: | non#1#94#94 |
| Context | Block#2: | bos#1#95#96 |
| Context | Block#3: | oos#1#96#99 |
| Context | Block#2: | bos#2#100#100 |
| Context | Block#5: | non#101#103 |

The hierarchical structure identification unit 300 identifies a hierarchical structure of resources included in the resource block. The hierarchical structure identification unit 300 identifies the hierarchical structure of the resources, for example, a parent-child resource relationship, by determining dependency between the resources in the resource block.

The hierarchical structure identification unit 300 inspects the dependency between resources, the order of use, and whether the resources are released. Specifically, the hierarchical structure identification unit 300 identifies the dependency between the resources using the resource block and the abstract syntax tree (AST) as input data. According to the embodiment, the dependency between the resources may be output as a resource dependency graph.

The hierarchical structure identification unit 300 applies three criteria in identifying the dependency between the resources.

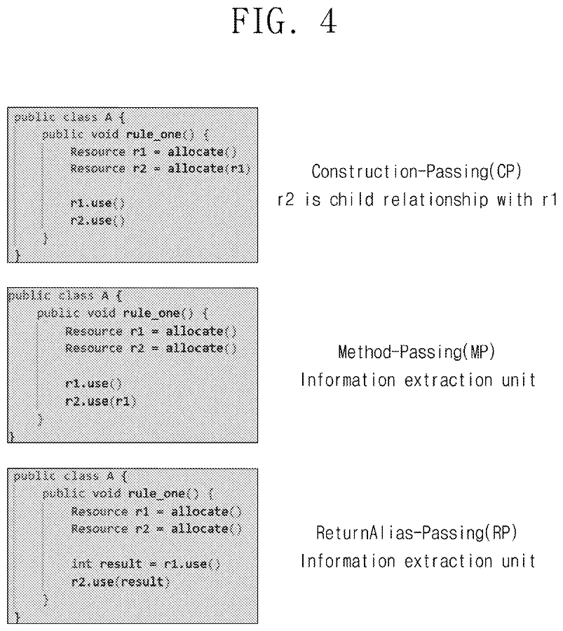

FIG. 4 is a view showing three criteria for identifying dependency between resources according to the embodiment of the present invention.

Referring to FIG. 4, the hierarchical structure identification unit 300 identifies dependency between resources by applying Construction-Passing, Method-Passing, and ReturnAlias-Passing.

The Construction-Passing, the Method-Passing, and the ReturnAlias-Passing are methods of transferring objects and methods in object-oriented programming.

When the Construction-Passing generates an object, the Construction-Passing initializes data on the object through a constructor and transfers the object to the method, and since a state of the object is set at once by including the object generation at the same time, readability of the code may be improved.

The Method-Passing is a method of accessing a method or attribute of a corresponding object by transferring an object to a specific method as a factor, and may manipulate a state of the existing object without generating a separate object when the method is called.

The ReturnAlias-Passing is a method in which, when the method returns the object, a reference (or alias) of the object is returned and a caller receives and uses the same.

[Table 3] is a table showing one example in which the hierarchical structure identification unit 300 according to the embodiment of the present invention identifies a hierarchical relationship of the resources by analyzing the resources in the source code shown in [Table 1].

TABLE 3

Context Block#2: bos#1#95#96
Context Block#3: oos#1#96#99
Context Block#2: bos#2#100#100

Referring to Table 3, a resource of resource block 2 in the resource block is “bos” and a resource of resource block 3 in the resource block is “oos”, and the resource of resource block 2 is different from the resource of resource block 3, but an end line of resource block 2 overlaps with a start line of resource block 3, so that it becomes an inspection target to determine what criteria the resource meets. Resource block 4 does not overlap with resource blocks 2 and 3, so that it is determined as a single resource.

In line 96 of Table 1, the resource “oos” may be determined as a statement that may not be executed without the resource “bos”. In addition, since it depends on the generator, it may be determined as Construction-Passing (CP). Accordingly, a matrix graph may be generated as the relationship between “bos” and “oos” is a relationship in which the parent is “bos” and the child is “oos”.

The resource leak correction unit 400 may correct the resource leak through a pre-trained artificial intelligence algorithm by using the source code and the hierarchical structure of the resource as input data. According to the embodiment, a large language model may be used as the artificial intelligence algorithm.

The following [Table 4] shows a basic system prompt of a prompt injected into the LLM.

TABLE 4
{system_prompt}
‘‘‘
### Instruction:
You need to fix a Resource Leak issue in Java code, with the
following five values provided:
JAVA_CODE: The Java code where the Resource Leak is occurring.
RESOURCE_LEAK_TYPE: Indicates whether the resource leak
involves multiple objects or a single object. It is set to
MULTI if there are two or more leaking objects, and SINGLE if
there is only one.
RESOURCE_OBJECT_NAME: The name of the the object(s) involved
in Resource Leak.
RESOURCE_DEPENDENCY: There are three types. 1) Method-Passing:
Object A is used when executing methods of object B. 2)
Constructor-Passing: Object A is used when executing the
constructor of object B. 3) Method-Passing: The return value
after executing object A is used when executing a method or
constructor of object B.
RESOURCE_CONTEXT: Describes the scope within which the
resources are used. This ensures that the original flow and
functionality of the code are preserved. Consider this context
carefully when modifying the code.
Please fix the Resource Leak in the given Java code.
You should use below additional information.
‘‘‘
system_prompt}
‘‘‘
### Instruction:
You should resolve resource leak issues in Java code using the
following five values.
JAVA_CODE: This is Java code that causes a resource leak.
RESOURCE_LEAK_TYPE: It indicates whether the resource leak is
associated with multiple objects or a single object. The
value is set as MULTI for multiple (two or more) leaking
objects and as SINGLE for a single leaking object.
RESOURCE_OBJECT_NAME: The name of the object involved in the
resource leak.
RESOURCE_DEPENDENCY: There are three types. 1) Method-Passing:
Object A is used to execute a method of object B. 2)
Constructor-Passing: Object A is used to execute a constructor
of object B. 3) Method-Passing: The return value after
executing object A is used to execute the method or constructor
of object B.
RESOURCE_CONTEXT: It describes the scope in which the resource
is used. This preserves the original flow and functionality
of the code. Please consider this context carefully when
modifying the code.
Please fix the resource leaks in the provided Java code.
You should use the additional information below.

The following [Table 5] is an example of configuring a prompt to be indicated to the LLM as the results of analysis in [Table 1] to [Table 3].

TABLE 5

{human_prompt}
‘‘‘
### Instruction:
Please fix the Resource Leak in the given Java code.
You should use below additional information.
### Input:
JAVA_CODE:
‘‘‘java
{code}
‘‘‘
RESOURCE_LEAK_TYPE:
‘‘‘
single resource leak
‘‘‘
RESOURCE_OBJECT_NAME:
‘‘‘
{″r1″, ″r2″}
‘‘‘
RESOURCE_DEPENDENCY:
‘‘‘
{″r2″: {″child″: ″r1(Constructor-Passing)″}}
‘‘‘
RESOURCE_CONTEXT:
‘‘‘
[{″type″: ″non″, ″id″: 1, ″startline″: 2433, ″endline″: 2433},
{″type″: ″r1″, ″id″: 1, ″startline″: 2434, ″endline″: 2434},
{″type″: ″non″, ″id″: 2, ″startline″: 2435, ″endline″: 2437},
[″type″: ″r1″, ″id″: 2, ″startline″: 2438, ″endline″: 2438}]
‘‘‘
### Response:
‘‘‘

The results of experiments, which is obtained using a dataset on the method for correcting a resource leak according to the embodiment of the present invention prepared through the above-described process and a method for correcting a resource leak according to a comparative example, will be described.

A state of the art (SOTA) model was used in the method for correcting a resource leak according to the comparative example.

In the first experiment, an NUR-1 (2018, SOAP) dataset used in the SOTA study was used. In this case, the NJP means a normalized Java resource. The dataset is a dataset concentrated on a single-resource leak, which includes 2,205 single-resource leaks and does not include multi-resource leaks.

In the second experiment, a JLeaks (2024, ICSE) dataset was used. The dataset consists of standard single-resource leaks, standard multi-resource leaks, and third-party resource leaks. In the embodiment, a dataset composed of 634 standard single-resource leaks, 107 standard multi-resource leaks, and 371 third-party-resource leaks was used.

The experimental environment was constructed using the GPT-40 version within the Langchain framework to compare the patch generation rate and patch accuracy.

Table 6 is a table showing patch generation rates in the first and second experiments of the method for correcting a resource leak according to the embodiment of the present invention and the method for correcting a resource leak according to the comparative example, and Table 7 is a table showing patch accuracy in the first and second experiments of the method for correcting a resource leak according to the embodiment of the present invention and the method for correcting a resource leak according to the comparative example.

TABLE 6

| | Comparative Example | | Present Invention | |
|---|---|---|---|---|
| | Single- | Multi- | Single- | Multi- |
| | resource | Resource | resource | resource |
| Classification | leak | Leaks | leak | Leaks |
| NJR-1 | 66% | 0% | 62% (−4%) | 0% |
| JLeaks | 22% | 13% | 79% (+57%) | 72% (+66%) |

TABLE 7

| | Comparative Example | | Present Invention | |
|---|---|---|---|---|
| | Single- | Multi- | Single- | Multi- |
| | resource | Resource | resource | Resource |
| Classification | leak | Leaks | leak | Leaks |
| NJR-1 | 95% | 0% | 92% (−3%) | 0% |
| JLeaks | 0% | 0% | 94% (+94%) | 97% (+97%) |

First, referring to Table 6, the method for correcting the resource leak according to the present invention showed a −4% lower patch generation rate of the single-resource leak in the NJR-1 dataset compared to the method for correcting a resource leak according to the comparative example, but showed 57% and 66% improvement in the single-resource leak and the multi-resource leak of the JLeaks dataset, respectively. Overall, the method for correcting a resource leak according to the present invention showed an improvement in patch generation rate of 57%.

Referring to Table 7, the method for correcting the resource leak according to the present invention showed −3% lower patch accuracy of the single-resource leak in the NJR-1 dataset compared to the method for correcting a resource leak according to the comparative example, but showed 94% and 97% improvement in the single-resource leak and the multi-resource leak of the JLeaks dataset, respectively. Overall, the method for correcting a resource leak according to the present invention showed an improvement in patch accuracy of 92%.

It was automatically verified whether compilation was possible after patching. It was manually verified whether the patch ensured the original control flow. The researcher and GPT-40 verify whether the control flow was not violated, and the correctness was determined based on agreement between two opinions.

Table 8 shows results of requesting correction of the resource leak to a GPT-40 model by applying the prompt prepared according to the embodiment of the present invention, and Table 9 shows results of requesting correction of the resource leak to a basic GPT-40 model without applying the prompt.

TABLE 8

| Dataset | All | Single | Multiple |
|---|---|---|---|
| NJR-1 | 57% (−2%) | 57% (−2%) | None |
| JLeaks | 65% (+18%) | 74% (+28%) | 64% |

TABLE 9

| Dataset | All | Single | Multiple |
|---|---|---|---|
| NJR-1 | 59% | 0% | None |
| JLeaks | 47% | 46% | 57% |

Referring to [Table 8] and [Table 9], as in the present invention, it was confirmed that when the hierarchical structure between the resources is identified and the resource leak is corrected, higher performance is shown compared to when the resource leak is corrected without the analysis.

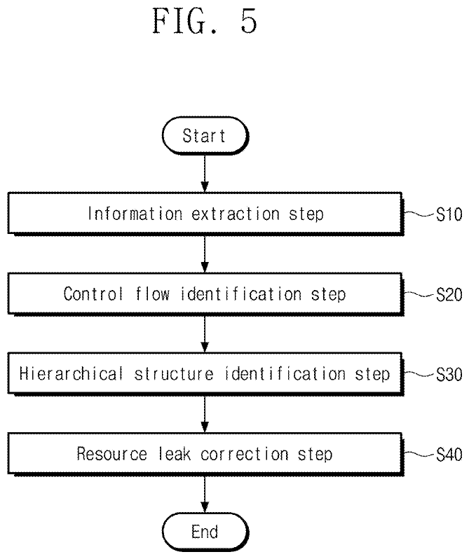

FIG. 5 is a flowchart showing a method for correcting a multi-resource leak according to an embodiment of the present invention.

Referring to FIG. 5, the method for correcting a multi-resource leak according to the embodiment of the present invention includes an information extraction step S10, a control flow identification step S20, a hierarchical structure identification step S30, and a resource leak correction step S40.

The information extraction step S10 includes extracting a source code and a resource leak from a dataset, and extracts a method including the resource leak. According to the embodiment, the information extraction step S10 includes extracting a start line (start_line) of the resource leak as information on the resource leak, and extracts a start line and an end line of the method as method information.

The control flow identification step S20 includes identifying a control flow of an original code by classifying a resource block related to the resource and a non-resource block not related to the resource in the method. To this end, the control flow identification step S20 includes performing a context analysis of the source code and the method. The control flow identification step includes outputting the resource block and the non-resource block by using the source code, the start line and the end line of the method, and an abstract syntax tree (AST) as input data.

The hierarchical structure identification step S30 includes identifying a hierarchical structure of resources included in the resource block. The hierarchical structure identification step S30 includes identifying a hierarchical structure of the resources, for example, a parent-child resource relationship, by determining dependency between the resources in the resource block.

The hierarchical structure identification step S30 includes inspecting the dependency between resources, the order of use, and the release of the resources. Specifically, the hierarchical structure identification step S10 includes identifying the dependency between the resources using the resource block and the abstract syntax tree (AST) as input data. According to the embodiment, the dependency between the resources may be output as a resource dependency graph.

In the hierarchical structure identification step S30, three criteria are applied in identifying the dependency between the resources. According to the embodiment, the hierarchical structure identification step S30 includes identifying dependency between resources by applying Construction-Passing, Method-Passing, and ReturnAlias-Passing.

The resource leak correction step S40 may include correcting the resource leak through a pre-trained artificial intelligence algorithm by using the source code and the hierarchical structure of the resource as input data. According to the embodiment, a large language model may be used as the artificial intelligence algorithm.

While the present invention has been described in connection with the embodiments, it is not to be limited thereto but will be defined by the appended claims. In addition, it is to be understood that those skilled in the art may substitute, change, or modify the embodiments in various forms without departing from the scope and spirit of the present invention.

What is claimed is:

1. A method for correcting a multi-resource leak, the method comprising:
an information extraction step of extracting a source code and a resource leak from a dataset and extracting a method including the resource leak;
a control flow identification step of identifying a control flow of an original code by classifying resource blocks related to resources in the method;
a hierarchical structure identification step of identifying a hierarchical structure of the resources included in the resource blocks; and
a resource leak correction step of correcting the resource leak through an artificial intelligence algorithm by using the source code and the hierarchical structure of the resources as input data.

2. The method of claim 1, wherein the information extraction step includes:
extracting a start line from the resource leak, and;
extracting a start line and an end line of the method through the start line of the resource leak.

3. The method of claim 2, wherein the control flow identification step includes outputting a block related to the resource as a resource block, and outputting a block not related to the resource as a non-resource block, by using the source code, the start line and the end line of the method, and the hierarchical structure (AST) of the source code as input data.

4. The method of claim 3, wherein the control flow identification step includes identifying the hierarchical structure of the resources by determining dependency between the resources included in the resource blocks.

5. The method of claim 1, wherein the artificial intelligence algorithm is a large language model (LLM).

6. A computer-readable recording medium storing a program for executing the method according to claim 1.

7. A device for correcting a multi-resource leak, the device comprising:
an information extraction unit configured to extract a source code and a resource leak from a dataset and extracting a method including the resource leak;
a control flow identification unit configured to identify a control flow of an original code by classifying resource blocks related to resources in the method;
a hierarchical structure identification unit configured to identify a hierarchical structure of the resources included in the resource blocks; and
a resource leak correction unit configured to correct the resource leak through an artificial intelligence algorithm by using the source code and the hierarchical structure of the resources as input data.

8. The device of claim 7, wherein the information extraction unit extracts a start line from the resource leak, and extracts a start line and an end line of the method through the start line of the resource leak.

9. The device of claim 8, wherein the control flow identification unit outputs a block related to the resource as a resource block, and outputs a block not related to the resource as a non-resource block, by using the source code, the start line and the end line of the method, and the hierarchical structure (AST) of the source code as input data.

10. The device of claim 9, wherein the control flow identification unit identifies the hierarchical structure of the resources by determining dependency between the resources included in the resource blocks.
